(19) United States
(12) Patent Application Publication
(10) Pub. No.: US 2002/0016775 A1
(43) Pub. Date: Feb. 7, 2002

(54) Content control method, content control device and program storage medium for storing content control program to control the contents

(76) Inventor: Susumu Nakagawa, Kanagawa (JP)

Correspondence Address: FROMMER LAWRENCE & HAUG LLP, 745 Fifth Avenue, New York, NY, 10151, US

(21) Appl. No.: 09/894,628

(22) Filed: Jun. 28, 2001

(30) Foreign Application Priority Data
Jun. 30, 2000 (JP) 2000-203140

(51) Int. Cl. G06F 17/60

(52) U.S. Cl. 705/52

(57) ABSTRACT

There is provided a content control method to allow easy use of contents by the user by controlling operating restrictions on the contents even when the contents are protected by copyright protection technology. Contents usage rights information CUD and status code information SC showing the usage status of contents CT are compared, and when the status code information SC is within the range of the contents usage rights information CUD, the status code information SC is compared with output setting information OI having a threshold value within the range of the contents usage rights information CUD, and when notified by a warning indicator data WID showing proximity to contents CT usage rights, the warning report data WID is outputted when status code information SC exceeds the output setting information OI.

### BACKGROUND OF THE INVENTION

1. Field of the Invention

The present invention relates to content control method, content control device and information storage medium for storing the contents control program and preferably relates to control of usage rights to contents such as music or video, etc.

2. Description of the Related Art

The spread of network technology such as the Internet in recent years has led to the distribution of contents such as music and video by way of the Internet. The content distributed over the Internet however has the drawback that the illegal or unauthorized copying of the contents is easily accomplished. Copyright protection technology has therefore currently been developed to safeguard the copyrights to the contents. One example of copyright protection technology is a method that distributes encoded contents and utilizes key code information to decode these contents.

Such key code information contains content usage right information that sets the range (or limits) within which the contents can be utilized (content usage rights). The user may utilize the contents within the range of the content rights. The contents therefore cannot be used unless the user has acquired the usage rights.

Method to acquire these usage rights may for example include a (purchase) method to acquire usage rights by paying a fee for the contents when the user obtains such contents, a (pay per play) method wherein the user pays money after having utilized the contents, a (count limit) method wherein the contents may be utilized only a specified number of times, and a method for using the contents only for a fixed amount of time, etc.

Further, the method for utilizing the contents only for a fixed amount of time may include, a method for specifying for example, a usage start time from January 1st until a usage end time of January 31st during which the contents can be used; a method in which the contents are utilized only until a specified end time after the purchase of the contents, a method in which the contents can be utilized only within a set usage time; and a method limiting the total time that the contents can be used, etc. Also, usage of the contents can be prohibited until a specified time so that utilization of the contents can be timed to start with the date that the contents go on sale.

The user may also wish to update usage rights to previously acquired contents. When for example, the user wants to collect a plurality of acquired contents in an album, change the usage rights of the acquired contents (switch from a count limit on usage rights to purchase of usage rights) or update the usage rights to the contents, then a request can be made for redistribution of the contents in order to use the acquired contents on another device, etc.

The owner of the contents can protect the contents from unauthorized use by utilizing this kind of copyright protection technology. However, the user may find the acquired contents are difficult to use due to the presence of such copyright protection technology.

When usage of the contents is for example restricted by a count limit (number of times the contents can be used) by copyright protection technology, the user may unknowingly reach the count limit or time limit for which the contents can used, causing the problem that the user is unable to utilize the contents when needed.

### SUMMARY OF THE INVENTION

Whereupon, in order to resolve the above mentioned problems in the related art, the present invention has the object of providing a content control method, a content control device and information storage medium for storing the contents control program to make utilization of the contents easier for the user by controlling operating restrictions on the contents even when the contents are protected by copyright protection technology.

According to one aspect of the present invention, the above objective is achieved by a contents control method for managing the contents based on key code information having content usage information set within a range where the contents can be utilized, wherein the content usage rights information are compared with status code information showing the usage status of the contents, and when the status code information is within the range of the contents usage rights information, the status code information is compared with output setting information having a threshold value within the range of the contents usage rights information when notified by warning indicator data cautioning that the contents usage rights are in proximity, and when the status code information exceeds the output setting information, the warning indicator data is outputted.

According to another aspect of the present invention, the above objective is achieved by a contents control device for managing the contents based on key code information containing content usage information set within a range where the contents can be utilized, wherein the contents control device comprises a memory storage means stored with the contents, the key code information, and status code information showing the usage status of the contents, and output setting information having a threshold value within the range of the contents usage rights information for warning by warning report data when in proximity to the contents usage rights; key code monitor means to control usage limits of the contents by comparing the contents usage rights, the status code information and the output setting information; and when the status code information exceeds the output setting information, the key code monitor means comprises a function to output the warning report data; and

the content output means contains a function to reproduce the contents of the memory storage means and a function to output the warning report data.

According to still another aspect of the present invention, the above objective is achieved by a program storage medium for storing the contents control program for managing the contents based on key code information containing content usage information set within a range where the contents can be utilized, wherein the medium comprises a memory storage means stored with the contents, the key code information, and status code information showing the usage status of the contents, and output setting information having a threshold value within the range of the contents usage rights information for warning by warning report data when in proximity to the contents usage rights; a key code monitor means to control usage limits of the contents by comparing the contents usage rights, the status code information and the output setting information; and when the status code information exceeds the output setting information, the key code monitor means comprises a function to output the warning report data and; a content output means contains a function to reproduce the contents of the memory storage means and a function to output the warning report data.

The structure of the present invention allows the user to utilize the contents within the range of the content usage rights information, and stores that usage status in the status code information when the user has utilized the contents. The contents usage rights information and the status code are then compared, and a determination made as to whether the contents are usable or not usable.

When determined that the contents are usable, the status code information is compared with the output setting information. When the status code information has reached the limits of the output setting information, warning report data is outputted to inform the user that the usable range of the contents is becoming small.

In other words, the user can grasp by means of this warning report data, the fact that the usage right deadline of the contents is near, before those content usage rights are actually gone. The user therefore knows in advance that contents usage rights are ending and so no longer faces the situation of suddenly being unable to utilize the contents.

### BRIEF DESCRIPTION OF THE DRAWINGS

FIG. 1 is a block diagram showing the structure of a preferred embodiment of the content control device of the invention.

FIG. 2A is a drawing showing a typical display screen of warning report data for the content control device of the invention.

FIG. 2B is a drawing showing a typical display screen of warning report data in an electronic mail transmission for the content control device of the invention.

FIG. 3A is a drawing showing typical key code information for the content control device of the invention.

FIG. 3B is a drawing showing typical license information for the content control device of the invention.

FIG. 3C is a drawing showing typical content usage rights for the content control device of the invention.

FIG. 3D is a drawing showing typical content information for the content control device of the invention.

FIG. 4A is a drawing showing typical status code information for the content control device of the invention.

FIG. 4B is a drawing showing typical license information for the content control device of the invention.

FIG. 4C is a drawing showing typical content usage rights for the content control device of the invention.

FIG. 5 is a drawing showing typical output setting information for the content control device of the invention.

FIG. 6 is a flowchart showing methods for outputting warning report data on the content control device of the invention.

FIG. 7 is a flowchart showing a preferred embodiment of the content control method of the invention.

FIG. 8 is a block diagram showing another embodiment of the content control device of the invention.

### DESCRIPTION OF THE PREFERRED EMBODIMENTS

The preferred embodiments of the invention are hereafter described in detail while referring to the accompanying drawings.

The embodiments described hereafter are preferred specific working examples of the invention, and are therefore accompanied by various preferred technical limitations. However, provided there is no specific restriction in the following description, the scope of the invention is not limited to these embodiments.

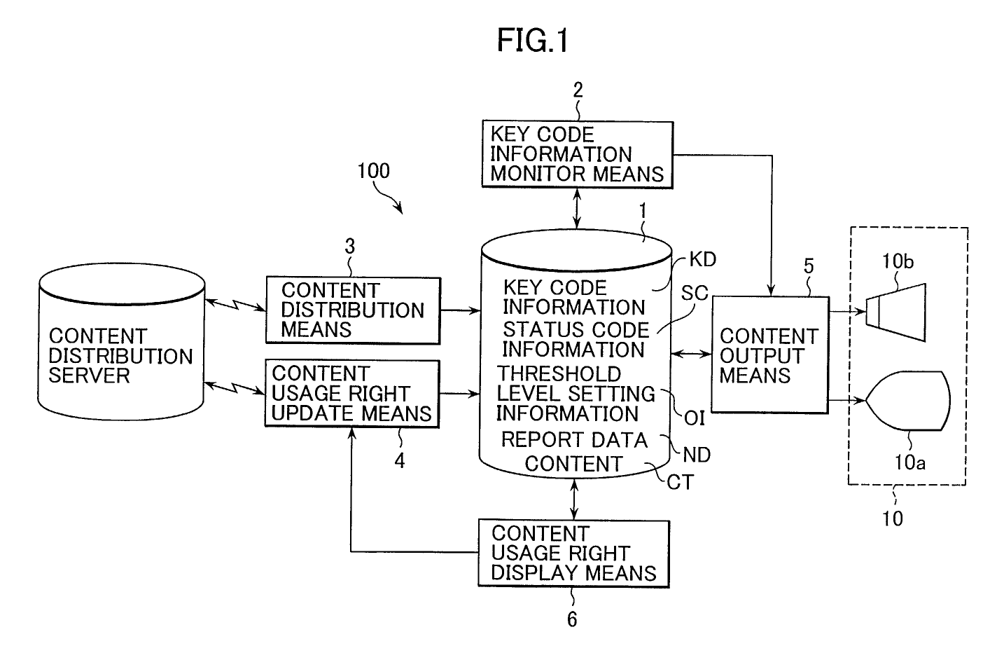

FIG. 1 is a block diagram showing the structure of a preferred embodiment of the content control device of this invention. A content control device 100 is described while referring to FIG. 1.

The content control device 100 of FIG. 1 is comprised for instance by a personal computer and further contains a memory storage means 1, a key code monitor means 2, a contents distribution means 3, a content usage right update means 4, and a content output means 5, etc.

The memory storage means 1 having a function to store information is comprised for example of a storage medium such as a magnetic disk device comprised of an hard disk drive, an optical disk device or a magneto-optical device. The memory storage means 1 stores the key code information KD, the status code information SC, the output setting information OI, the various types of report data WID, IID, DID and the contents CT.

The key code monitor means 2 monitors the status code information SC and output setting information OI and key code information KD stored in the memory storage means 1, and has a function to make unusable the contents CT that have exceeded the range of the contents CT usage rights. The user therefore becomes unable to use the contents CT that have exceeded the range of the contents CT usage rights and the copyrights to the contents CT are protected.

The key code monitor means 2 has a function to report to the user the information that use of the contents CT is disabled by sending invalidation report data IID to the information output means 10 by way of the contents output means 5. The user is notified with this invalidation report data IID from the information output means 10 and the user can therefore know that the contents CT are invalid (unusable).

The key code monitor means 2 has a function to monitor the content usage right information CUD as well as the usage status information CU and to output the warning report data WID on the information output means 10 when then usage restriction (or limit) on the contents CT is near. Usage of the contents CT is restricted by the content usage right information CUD as described above. Therefore, even if the user attempts to utilize the contents CT, the case will occur that the contents CT cannot be utilized due to this usage restriction. Whereupon, by outputting the warning report data WID based on the content usage right information CUD and usage status information CU, the user can know that the usage restriction (or limit) on the contents CT is near. The problem of the user suddenly being unable to utilize the contents CT is therefore prevented, and the interface with the user is improved.

The key code monitor means 2 also has a function to delete the contents CT of the memory storage means 1 when the elapsed time set on the output setting information OI (described later on) is exceeded after the contents CT have become invalid. The unauthorized used of the contents CT can in this way be prevented. The key code monitor means 2 also has a function to send deletion report data DID to report deletion of the contents CT to the information output means 10 by way of the contents output means 5. The user can therefore know that the contents CT have been deleted by the deletion report data DID outputted from the information output means 10.

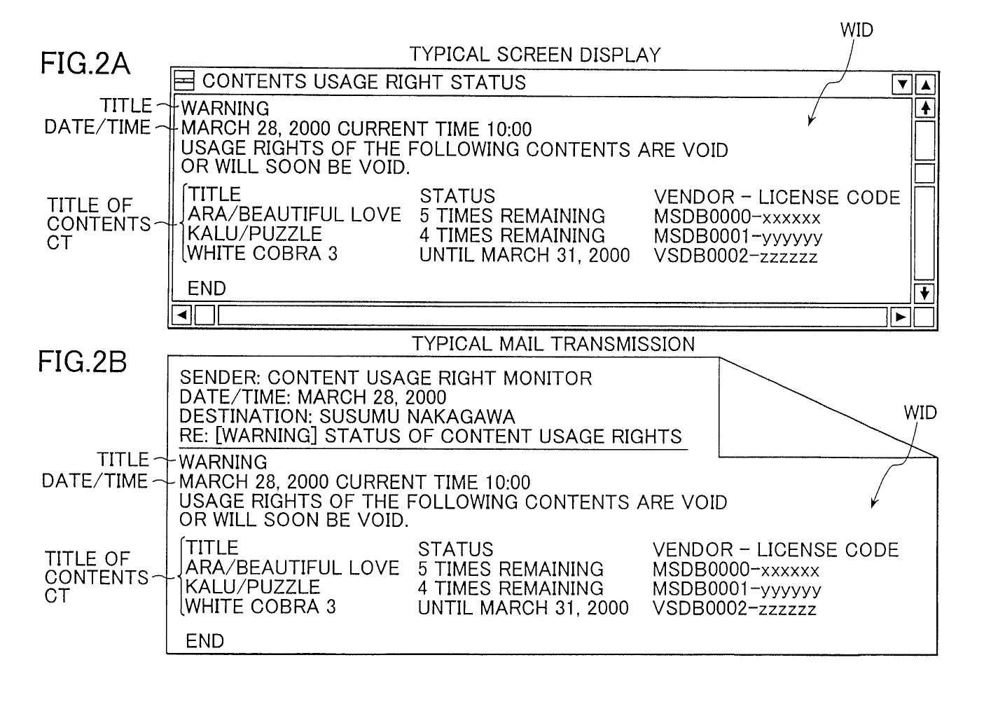

The warning report data WID outputted from the key code monitor means 2 is displayed here on a window by the screen display means 10a as shown for example in FIG. 2A. Alternatively, the warning report data WID may be sent by electronic mail as shown in FIG. 2B. The warning report data WID may contain for example, a title informing of the warning, the data and time of the warning, and the title name of the contents CT, etc. Examples of the warning report data WID are shown in FIG. 2A and FIG. 2B however, the invalidation report data IID and the deletion report data DID are also outputted in the same format.

A contents distribution means 3 of FIG. 1 has a function to acquire for example the contents CT from the contents distribution server present on the network such as the Internet, and store the contents CT in the memory storage means 1.

A contents usage right information means 4 has a function to access the contents distribution server in order to newly acquire the key code information KD according to the acquired contents CT, or distribute or rewrite the previously acquired key code information KD.

A contents output means 5 provides the contents CT stored in the memory storage means 1 to the user by way of the information output means 10. The information output means 10 here has for example a screen display means 10a and a speaker 10b. An image or video is outputted from the screen display means 10a and the audio is outputted from the speaker 10b.

The contents output means 5 further has a function to output the warning report data WID, the invalidation report data IID and the deletion report data DID sent from the key code monitor means 2, to the information output means 10.

The contents output means 5 further has a function to rewrite (or update) the usage status information CU of the status code information SC each time the contents CT are reproduced (played), and store the usage status information CU in the memory storage means 1.

A contents usage rights display means 6 has a function to output by user operation, the contents usage right information CUD to the information output means 10. The contents usage rights display means 6 also has a function to send the key code information KS containing contents usage right information CUD to the contents distribution means 3, when instructions are received to rewrite the contents usage right information CUD displayed by the user.

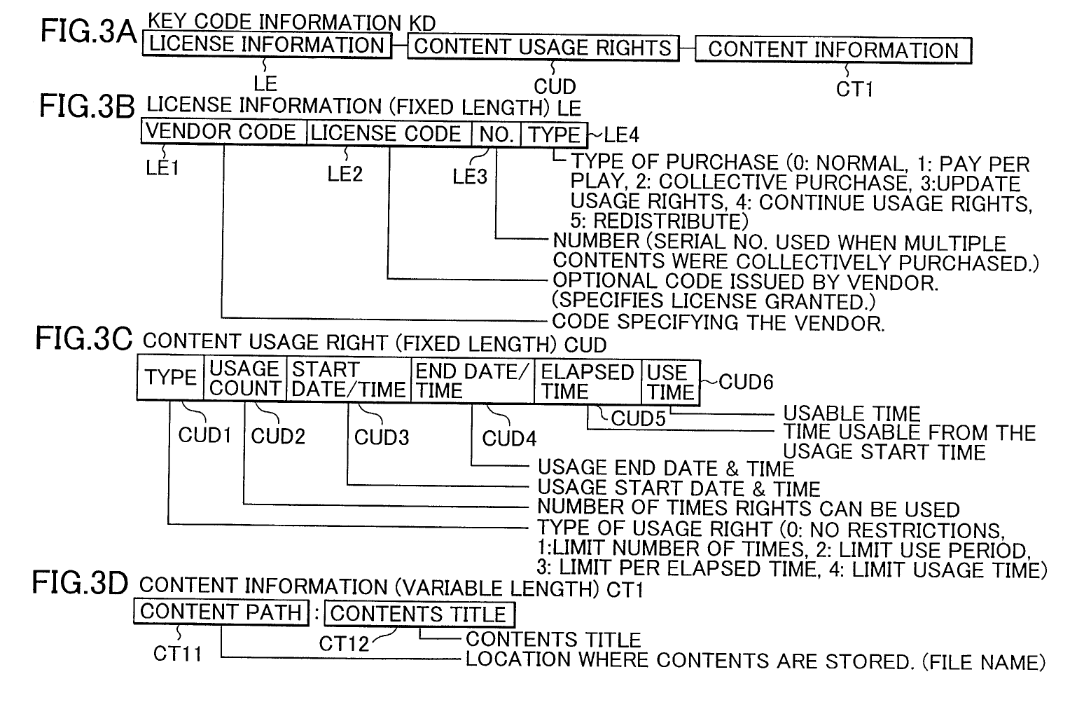

An example of the data structure of the key code information KD is shown in FIG. 3A through FIG. 3D. The key code information KD is described while referring to FIG. 3A through FIG. 3D.

The key code information KD along with having information for decoding the encrypted contents to allow utilizing the acquired contents CT, also has information on contents usage rights to allow utilization by the user. The copyrights of the contents CT are protected by this key code information KD.

The key code information KD of FIG. 3A more specifically, is comprised of the license information LE, the contents usage right information CUD, and the contents information CTI. The license information LE of FIG. 3B shows information on the providing source having the copyrights for the contents CT. This license information LE contains a vendor code LE1 specifying for example, the vendor (provider), a license code LE2 issued by the vendor for specifying the license being granted, a serial number LE3 assigned when a plurality of contents CT were collectively purchased, and a configuration (or type) code LE4 showing the type of purchase of the contents CT.

The contents usage right information CUD of FIG. 3C is information expressing the range of the usage rights granted by the vendor, and the user may utilize the contents CT within the range of the contents usage right information CUD. The contents usage right information CUD contains for example, a type code CUD1 showing information on the restriction of usage rights, a usage count CUD2 showing the number of times for using the contents CT, the start date/time information CUD3 showing the start date and time from which the contents CT can be utilized, the end date/time CUD4 showing the usable end time until which the contents can be used, the elapsed time CUD5 showing the time the contents can be used from the contents usage start time, and the use time CUD6 showing the time that the contents can be used. The type code CUD1 shows the types of (limit) settings within a range usable for the information contents CUD2 through CUD6, and usage of the contents CT is restricted by the information contents of CUD2 through CUD6 shown by the type code CUD1.

The content information CTI of FIG. 3D is information associating the contents CT and the key code information KD, and has for example, a contents path CTI1 showing the location (file name) in the memory storage means 1 where the contents CT are stored, and the contents title information CTI2 showing the title of the CT contents.

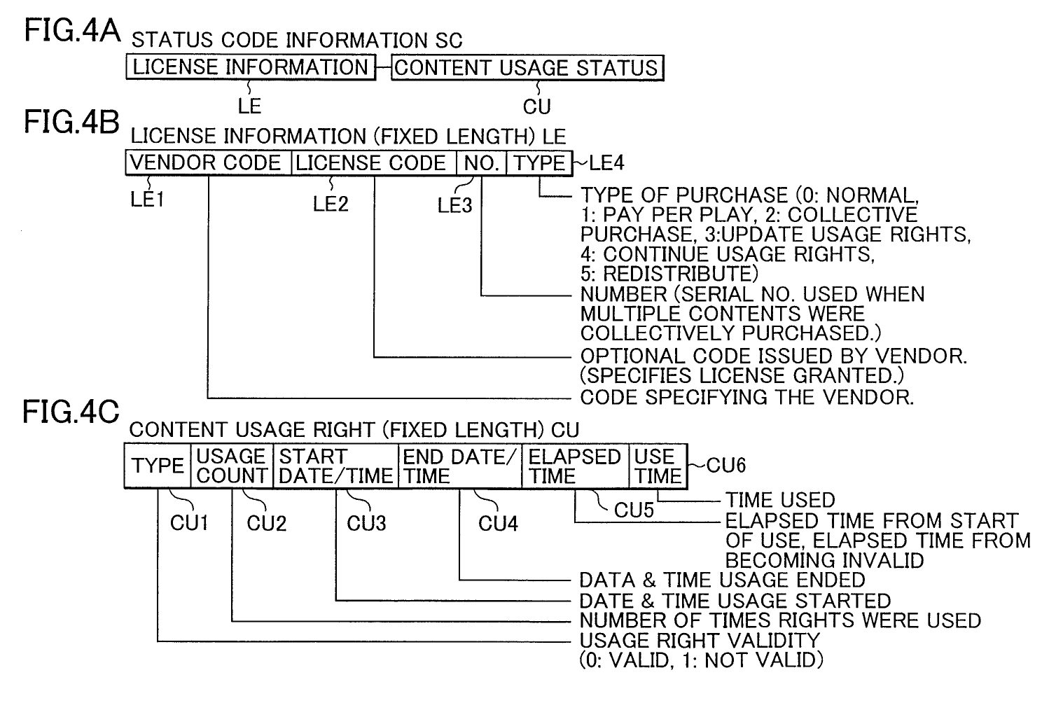

A typical data configuration of the status code information SC is shown in FIG. 4A through 4C. The status code information SC is described while referring to FIG. 4A through 4C. The status code information SC shows the usage status of the user's content CT.

The status code information SC of FIG. 4A has the license information LE and the contents usage status information CU. The license information LE of FIG. 4B shows information on the provider source having the contents CT copyrights, and has the same data structure as the license information LE of FIG. 3B. The license information LE therefore is comprised of a vendor code LE1 specifying a vendor, a license code LE2 issued by the vendor for specifying a license to be granted, a serial number LE3 assigned when a plurality of contents CT were collectively purchased, and a configuration (or type) code LE4 showing the type of purchase of the contents CT.

The usage status information CU of FIG. 4C is comprised for example of type code CU1 showing the contents of the usage rights, a usage count CU2 showing the number of times the contents CT are used, a start date/time information CU3 showing the data and time that use of the contents CU commenced, an end date/time information CU4 showing the date and time the contents CT were last used, or the elapsed time information CU5 showing the elapsed time from when the contents CT became invalid, and the use time information CU6 showing the time that the contents CT were used.

The data in the usage status information CU is rewritten when the contents CT are used by the user. When the user for example, uses the contents CT one time, the usage count information CU2 in the usage status information is rewritten so as to be increased by one.

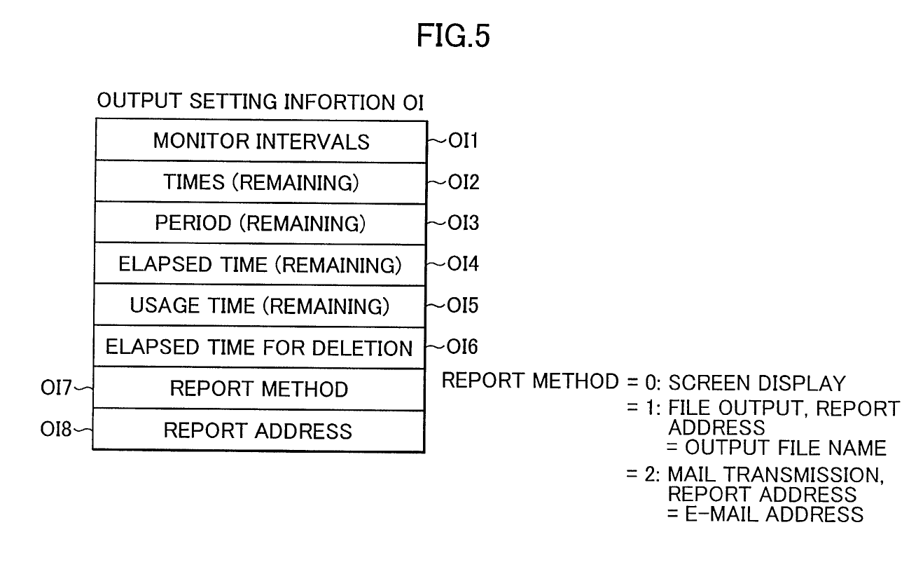

FIG. 5 is a drawing showing a typical data configuration for output setting information OI. The output setting information OI contains information such as limit threshold values used when the key code information means 2 is outputting the warning report data WID. The usage status information CU is rewritten when the user has utilized the contents CT, and upon reaching the contents usage right information CUD, the contents CT become unusable. At this time, prior to the usage status information CU reaching the contents usage right information CUD, the warning report data WID is outputted to the user by the key code monitor means 2. The output setting information IO is the standard (or reference) used when outputting that warning data. This output setting information IO is set for example, by entries by the user.

The output setting information IO is comprised of monitor interval information OI1, times (count) information OI2, period information OI3, elapsed time information OI4, usage time information OI5, elapsed time to deletion information 016, report method information OI7, and report address information OI8, etc.

The monitor interval information OI1 is set with the loading intervals for the key code monitor means 2 to read the key code information KD and the status code information SC. This monitor interval information OI1 possesses schedule information such as when the contents CT are reproduced (played), when the contents control device 100 is started up and logged on or once a month, etc.

The times (count) information OI2, period information OI3, elapsed time information OI4, usage time information OI5 are respectively times (count), periods, elapsed time from content distribution, and usage time of the contents CT for reporting the warning data WID. The warning data WID is outputted when the remaining contents usage rights (CUD-CU) have become less (shorter) than the data set by these OI information.

The elapsed time to deletion information OI6 is set with the time from invalidation of the contents CT until the deletion of the contents CT. The report method information OI7 specifies the output method when outputting warning data such as warning data WID and for example, specifies an output method by electronic mail and an output method for the screen display means 10a. The report address information OI8 is set with the appropriate mail address when electronic mail was designated as the report method.

The operation of the contents control device 100 is next described while referring to FIG. 1 and FIG. 2, and FIG. 3A through FIG. 3D.

First of all, the contents distribution means 3 of FIG. 1 connects to the contents distribution server 100 at the request of the user and acquires the contents CT. The specified desired contents CT are then sent to the contents distribution means 3 from the contents distribution server 100. The contents distribution means 3 then stores the acquired contents CT in the memory storage means 1.

The contents usage right information means 4 on the other hand, acquires the key code information KD of the acquired contents CT from the contents distribution server 100, and stores the contents CT key code information in the memory storage means 1.

The contents output means 5 then starts up and the contents CT are outputted from the information output means 10. The contents output means 5 at that time has the status code information SC rewritten.

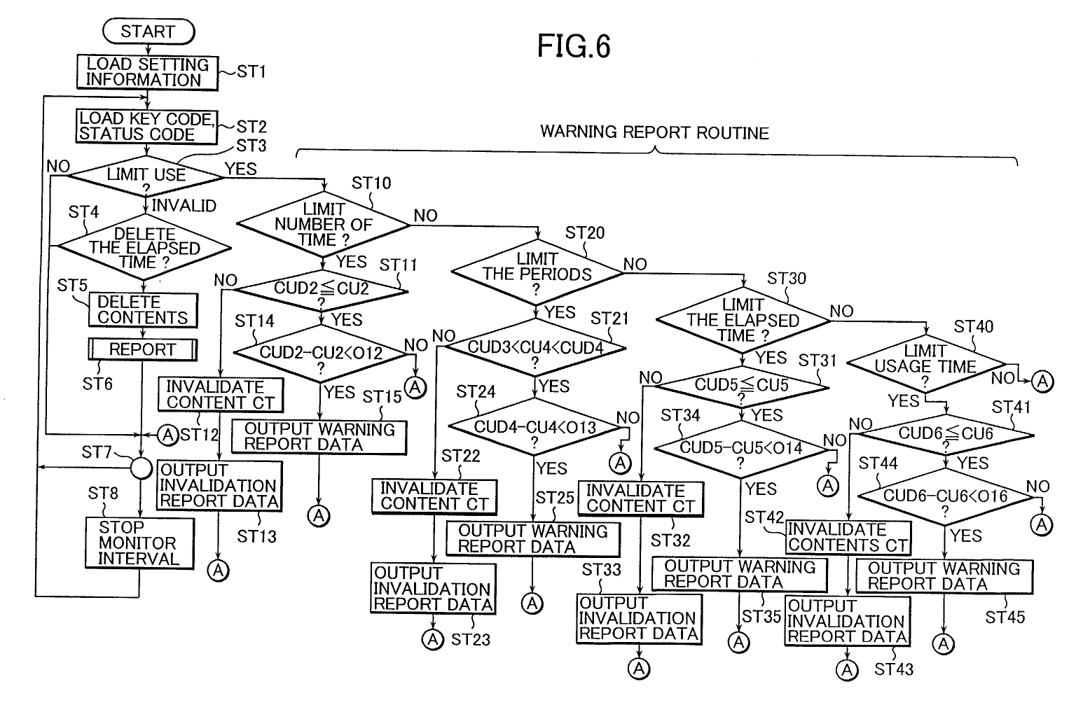

FIG. 6 is a flowchart showing the preferred embodiment of the contents control method of the present invention. The contents control method is described while referring to FIG. 1 through FIG. 6.

First of all, in ST1 of FIG. 5, the output setting information I/O is loaded into the key code monitor means 2 from the memory storage means 1. In step ST2, the key code information KD and the status code information SC are loaded into the key code monitor means 2.

Then, in step ST3, whether or not a usage restriction (limit) has been assigned to the contents CT is determined from the type information CUD1 of the content usage right information CUD. When a usage restriction (limit) has not been assigned to the contents CT, the monitoring of the contents CT is then stopped by means of the key code monitor means 2.

However, when a usage restriction (limit) has been assigned to the contents CT, a determination is made as to whether that content usage right information CUD is valid or invalid. In other words, in the warning report routine described later on, the contents CT are set to become unusable when the usage status information CU has reached the contents usage right information CUD. The validity of those contents is determined by the key code monitor means 2.

When use of the contents CT has become invalid, a determination is made as to whether or not the elapsed time information CU5 which is the elapsed time after the contents CT become invalid, has reached the elapsed time to deletion OI6 of output setting information OI. When the elapsed time information CU5 has reached the elapsed time to deletion OI6, then the contents CT are deleted from the contents storage area 1a by the key code monitor means 2 in ST5. Deletion report data DID for reporting that the contents CT have been deleted is then outputted from the key code monitor means 2 to the information output device 10 in ST6 and reported to the user.

However, when the elapsed time information CU5 has not reached the elapsed time to deletion OI6, then the elapsed time information CU5 is rewritten, and the monitoring of the contents CT by the key code monitor means 2 stops in ST8. The contents CT are not deleted at this time from the memory storage means 1, to provide for the case that the user rewrites the key code information KD and will further user the contents CT.

The warning report routine (ST10 through ST40) for reporting to the user when the usage restriction (limit) on the contents CT is approaching is described next.

First of all, when decided in ST3, that the contents usage right information CUD is valid, which restriction has been applied from among those in the contents usage right information CUD is determined in ST10, ST20, ST30 and ST40. More specifically, which restriction (limit) from among the usage count information CUD2, start date/time information CUD3, end date/time information CUD4, elapsed time information CUD5, and use time information CUD6 is determined based on the type information CUD1.

When then determined in ST10, that the count information CU2 has been applied, a determination is made in ST11 as to whether or not the usage count information CUD2 of the usage status information CU has reached the usage count information CUD2 of the contents usage right information CUD. When the count information CU2 has reached the usage count information CUD2 (CU2≦CUD2), then the range that the contents CT can be used has been exceeded and the contents CT are made invalid in step ST12. Afterwards, in ST13, information that the contents CT cannot be used is outputted as invalidation report data IID by the key code monitor means 2 and the user notified. The monitoring of the contents CT then stops in ST8.

However, when the count information CU2 is within the range of the usage count information CUD2, in ST14 the key code monitor means 2 determines whether or not the remaining usage count (CUD2−CU2) is less than the times (count) information OI2 of the output setting information OI. Then, when the remaining usage count (CUD2−CU2) has become less than the times (count) information OI2, the remaining number of times that the contents CT can be used is determined to be small. The warning report data ST15 is at this time sent from the key code monitor means 2 to the information output means 10 in ST15, and the user notified with the warning.

Next, in ST20, when determined that a period restriction (limit) has been applied, a determination is made in ST21 whether or not the usage date/time CU4 (current date/time) is within the range of the start date/time information CUD3 and the end date/time information CUD4. Then, when found that the usage date/time CU4 (current date/time) is not within the range of the start date/time information CUD3 and the end date/time information CUD4 (CU4<CUD3, CU4>CUD4), in ST22 the contents CT are invalidated, to make the contents CT unusable. Afterwards, in ST23, the information that the contents CT are unusable is outputted by the key code monitor means 2 as invalidation report data IID and the user notified. The monitoring of the contents CT then stops in ST8.

On the other hand, when determined that the usage date/time CU4 (current date/time) is within the range of the start date/time information CUD3 and the end date/time information CUD4 (CUD3≦CU4≦CUD4), a determination in made in ST24 by the key code monitor means 2 as to whether the remaining time that the contents can be used (CUD4−CU4) is shorter than the period information OI3 of the output setting information OI.

When the remaining usable time (CUD4−CU4) is less than the period information OI3, the remaining time that the contents CT can be used is determined to be short by the key code monitor means 2. The warning report data WID is then sent from the key code monitor means 2 to the information output means 10 in ST25, and the user notified with the warning.

Next, in ST30 when determined that an elapsed time restriction (limit) has been assigned, a determination is made in ST31 as to whether the elapsed time information CU5 of the usage status information CU has reached the elapsed time information CUD5 of the contents usage right information CUD. Then when the elapsed time information CU5 has reached the elapsed time information CUD5 (CU5≦CUD5), the contents CT have exceeded the usable range and are invalidated as contents CT in ST32. Afterwards, in ST33, the information that the contents CT are unusable is outputted as invalidation report data IID by the key code information means 2 and the user notified. Then, the monitoring of the contents CT is stopped in ST8.

However, when the elapsed time information CU5 is within the range of the elapsed time information CUD5, the key code monitor means 2 determines whether or not the elapsed remaining time (CUD5−CU5) has become shorter than the elapsed time information OI4 of the output setting information OI. Then, when the elapsed remaining time (CUD5−CU5) has become shorter than the elapsed time information OI4, the remaining time that the contents CT can be used is determined to be short. In ST35, the warning report data WID is then sent from the key code monitor means 2 to the information output means 10, and the user notified with the warning.

Next, in ST40, when determined that a usage time restriction (limit) has been applied, a determination is made in ST41 as to whether or not the use time information CU6 of the usage status information CU has reached the use time information CUD6 of the content usage right information CU6. When the use time information CU6 then reaches the use time information CUD6 (CU6≦CUD6), the contents CT have then exceeded the usable range and are invalidated as contents CT in ST42. Afterwards, in ST43, the information that the contents CT are unusable is outputted as invalidation report data IID by the key code information means 2 and the user notified. The monitoring of the contents CT is stopped in ST8.

However, when the time information CU6 is within the range of the use time information CUD6, the key code information monitor means 2 determines in ST44, whether or not the remaining use time (CU6−CUD6) has become shorter than the output setting information OI5 during use of the output setting information OI. When the remaining usage right information CU6 has become shorter than the usage time output information OI5, the remaining time that the contents can be used is then determined to be small. The warning report data WID is sent in ST45 from the key code monitor means 2 to the information output means 10, and the user notified with the warning.

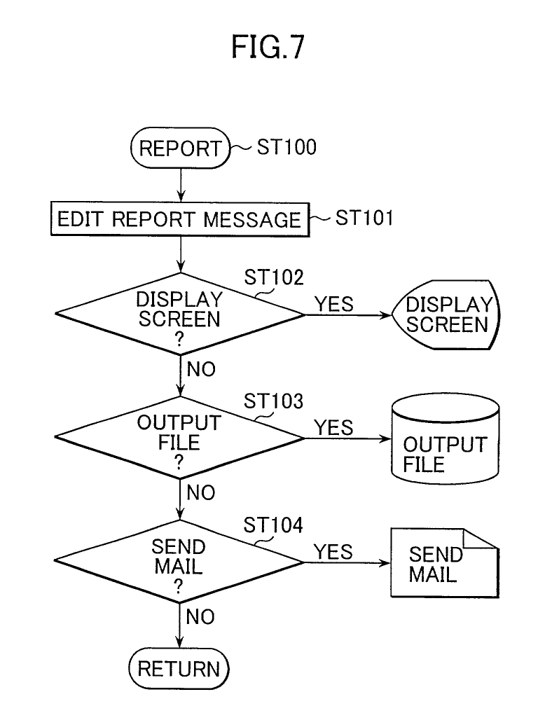

Here, FIG. 7 is a flowchart showing a method for outputting various types of data in the content control method of the present invention. The method for outputting the various data types is next described while referring to FIG. 7.

In ST100 first of all, the key code monitor means 2 decides to output the warning report data WID, invalidation report data IID or the deletion report data DID. The key code monitor means 2 then loads the report method in the output setting information OI. Then, in ST101, the key code monitor means 2 edits the warning report data WID, invalidation report data or the deletion report data. Afterwards, the key code monitor means 2 loads the report method information OI7 in the output setting information and decides on the reporting method to the user.

When a method is specified for outputting the various report data WID, IID, DID on the screen is specified as the report method in ST102, the key code monitor means 2 outputs the various edited report data WID, IID, DID to the screen display means 10a by way of the content output means 5.

When a method for outputting the report data WID, IID, DID as the report method in a file format is specified in ST103, the key code monitor means 2 stores the various edited report data WID, IID, DID for example as a text file in the memory storage means 1.

In ST104 on the other hand, when outputting the various report data as electronic mail (described later on) is specified as the report method in ST104, the key code monitor means 2 outputs the changed various report data WID, IID, DID to the contents output means 5 in an electronic mail format. Then, the contents output means 5 as described later on, sends the various report data WID, IID, DID as electronic mail to the mail address information OI8 of the output setting information OI.

The user can in this way be notified with a warning when the contents CT have little usable remaining range. Based on this warning, the user can then take measures such as updating the usage rights to the contents or deleting the contents CT, etc. The problem of the contents CT suddenly becoming unusable can therefore be avoided and the interface with the user in this way improved.

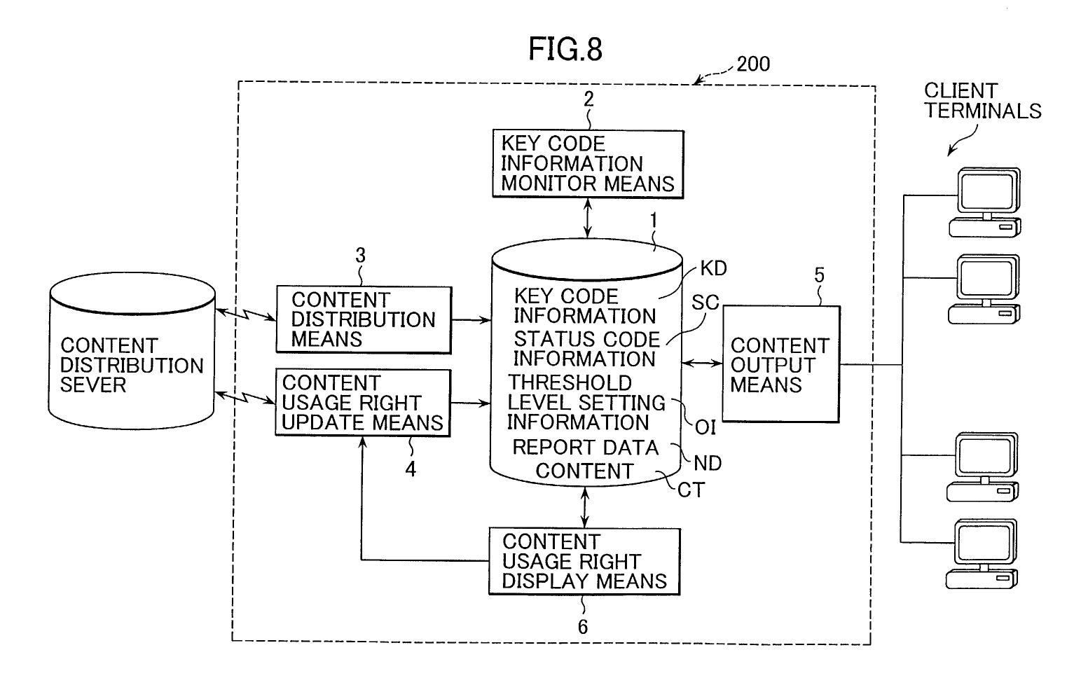

FIG. 8 is a block diagram showing another embodiment of the content control device of the present invention. The content control device is described while referring to FIG. 8. In the content control device 200 of FIG. 8, members having the same reference numerals as the structural members of the contents control device 100 of FIG. 1 are identical so an explanation is omitted here.

The contents control device 200 is an input and output device used when transferring data between networks referred to as so-called gateways. The contents control device 200 is configured of networks able to transfer data such as a plurality of personal computers or television receivers (hereafter, “client terminals”) within the home. A contents output means 50 has a function to transfer the contents CT of the memory storage means 1 to each client terminal.

The contents output means 5 further has a function to send the warning report data WID, invalidation report data IID or the deletion report data DID as electronic mail as described above. These warning report data WID, invalidation report data IID and deletion report data DID is then reported to the user based on the flowcharts shown in FIG. 6 and FIG. 7.

In the above described embodiments, the contents CT consisting for example of music or video distributed by utilizing the Internet, are encoded to protect the contents CT copyrights, a key code information KD for reproducing (playback), viewing and listening is issued, and rights to use of the contents CT are granted to the user. By monitoring and controlling the validity of the usage rights to the contents CT from this key code information KD, the user is no longer confronted with the situation of “not being able to hear something when I want to hear it” and “not being able to view something when I want to view it” and the contents distributed over the Internet can therefore be enjoyed. The effect obtained from controlling the content usage rights becomes much larger, especially when distributing the contents CT for a fee.

The managing of the contents usage right is also easier for the user so that there will be a greater increase in demand for the contents and the owner of the contents and the distributor of the contents can therefore expect an expanded business due to the wider spread of the contents CT.

The embodiments of the present invention are not limited by the working examples described above.

The structure of the contents control device 100 as shown in FIG. 1, is achieved by an auxiliary memory device of a computer, such as the information processing program of a hard disk implemented by a CPU (central processing unit). Further, the program to implement the following processing sequence may be installed in a computer, and the program storage medium utilized for achieving a state implemented by computer, may for example, not only consist of a packaged medium such as a floppy disk, CD-ROM, or DVD but may also be achieved with a semiconductor memory or a magnetic disk for temporarily or permanently storing the program. A cable or a wireless communication media such as a local area network or the Internet or a digital broadcast method may be utilized as the means to store the program in these program recording mediums, and the programs may also be stored by way of various types of communication interfaces such as routers and modems.

In the warning routine in FIG. 6, processing was performed in the sequence of limiting the number of times (count), limiting the period, limiting the elapsed time, and limiting the use time, however the processing does not have to be performed in such a sequence (ST10 through ST40). Further, when a plurality of settings were made for limits on use, a warning report routine is performed for all the limits on use set in ST7 of FIG. 6.

What is claimed is:

1. A contents control method for managing said contents based on key code information containing content usage information set within a range that the contents can be utilized, said method comprising the steps of:
comparing said content usage rights information with status code information showing the usage status of said contents;
comparing said status code information with output setting information having a threshold value within the range of said contents usage rights information to warn by warning report data when in proximity to said contents usage rights in the case where said status code information is within the range of said contents usage rights information; and
outputting said warning report data when said status code information exceeds said output setting information.

2. A contents control method according to claim 1, wherein when said status code information reaches the contents usage information, usage of said contents is prohibited and invalidation report data is outputted, reporting that use of said contents has been prohibited.

3. A contents control method according to claim 1, wherein a deletion elapse time for setting a period from prohibiting usage of said contents to deletion of said contents is set in said output setting information, and when the period from prohibiting usage of said contents to said deletion elapse time is reached, said contents are deleted and deletion report data is outputted to report said contents have been deleted.

4. A contents control method according to claim 1, wherein loading period information set with the loading timing for loading said contents usage right information, said status code information and said output setting information are set in said setting information, and said status code information, said contents usage information and said setting information are compared based on said loading interval information.

5. A contents control method according to claim 1, wherein said warning report data, said invalidation report data and said deletion report data are respectively outputted to screen display means.

6. A contents control method according to claim 1, wherein said warning report data, said invalidation report data and said deletion report data are respectively outputted as electronic mail.

7. A contents control device for managing said contents based on key code information containing content usage information set within a range where the contents can be utilized, said device comprising:
memory storage means stored with said contents, said key code information, and status code information showing the usage status of said contents, and output setting information having a threshold value within the range of said contents usage rights information for warning by warning report data when in proximity to said contents usage rights;
key code monitor means to control usage limits of said contents by comparing said contents usage rights, said status code information and said output setting information, said key code monitor means comprising a function to output said warning report data when said status code information exceeds said output setting information; and
content output means containing a function to reproduce said contents of said memory storage means and a function to output said warning report data.

8. A program storage medium for storing the contents control program for managing said contents based on key code information containing content usage information set within a range where the contents can be utilized, said medium comprising:
memory storage means stored with said contents, said key code information, and status code information showing the usage status of said contents, and output setting information having a threshold value within the range of said contents usage rights information for warning by warning report data when in proximity to said contents usage rights;
key code monitor means to control usage limits of said contents by comparing said contents usage rights, said status code information and said output setting information, said key code monitor means comprising a function to output said warning report data when said status code information exceeds said output setting information; and
said content output means containing a function to reproduce said contents of said memory storage means and a function to output said warning report data.
